(19) United States
(12) Patent Application Publication
(10) Pub. No.: US 2015/0119492 A1
(43) Pub. Date: Apr. 30, 2015

(54) TIRE TREAD

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CN)

(72) Inventors: Didier Vasseur, JR., Clermont-Ferrand (FR); Christine Nourry, Clermont-Ferrand (FR); David Lavialle, Clermont-Ferrand (FR)

(73) Assignees: MICHELIN RECHERCHE ET TECHNIQUE, S.A., Granges-Paccot (CH); COMPAGNIE GENERALE DES ETABLISSEMENTS MICHELIN, Clermont-Ferrand (FR)

(21) Appl. No.: 14/398,813

(22) PCT Filed: Apr. 19, 2013
(86) PCT No.: PCT/EP2013/058154

§ 371 Date: Nov. 4, 2014

(30) Foreign Application Priority Data
May 4, 2012 (FR) 1254116

(51) Int. Cl. C08L 9/06

(52) U.S. Cl. CPC C08L 9/06
USPC 523/156

(57) ABSTRACT

A tire, the tread of which comprises a rubber composition comprising at least:
one diene elastomer,
one reinforcing filler,
one plasticizing system comprising at least one thermoplastic hydrocarbon resin and at least one plasticizer based on one or more isosorbide diesters of following general formula (I):

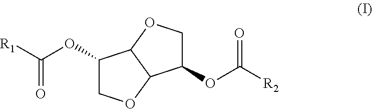

in which the R₁ and R₂ radicals, which are identical or different, independently represent a hydrocarbon radical comprising from 1 to 30 carbon atoms.

This application is a 371 national phase entry of PCT/EP2013/058154, filed 19 Apr. 2013, which claims benefit of FR 1254116, filed 4 May 2012, the entire contents of which are incorporated herein by reference for all purposes.

### BACKGROUND

1. Field

The field of the disclosure is that of tire rubber compositions, more specifically tread rubber compositions.

2. Description of Related Art

A tread has to meet, in a known way, a large number of often conflicting technical requirements, including a low rolling resistance, a high wear resistance and both a high dry grip and a high wet grip.

These compromises in properties, in particular from the viewpoint of the rolling resistance and the wear resistance, were able to be improved in recent years with regard to energy-saving Green Tires. These said tires are intended in particular for passenger vehicles as a result of the use of novel weakly hysteretic rubber compositions. These rubber compositions are currently reinforced predominantly with specific inorganic fillers, described as reinforcing fillers, such as highly dispersible silicas, referred to as “HDSs”, which can rival, from the viewpoint of the reinforcing power, conventional tire-grade carbon blacks.

The enhancement in the wear resistance properties remains, however, a constant preoccupation of designers of tires.

Provision has been made, in order to increase the wear resistance and abrasion resistance of treads, to use novel plasticizers comprising a mixture of nonaromatic oils of the MES or TDAE type and of terpene hydrocarbon resins of limonene type, or also of C₅ fraction/vinylaromatic copolymer or terpene/vinylaromatic copolymer hydrocarbon resins (see Patent Applications WO 2005/087859, WO 2006/061064 and WO 2007/017060).

Provision has been made, in Application WO 2004/022644, in order to improve the grip of tires on wet, snowy or icy ground, for a mixture of plasticizers comprising a glycerol fatty acid triester, such as a sunflower vegetable oil having a high content of oleic acid, and a plasticizing hydrocarbon resin.

### SUMMARY

On continuing their research, the Applicant Companies have discovered a specific plasticizing agent, hitherto reserved for other technical fields, which makes it possible to again reduce the rolling resistance of tires without damaging their wear resistance, while exhibiting a suitable processability.

A subject-matter of the invention is thus a tire, the tread of which comprises a rubber composition comprising at least:

one diene elastomer,
one reinforcing filler,
one plasticizing system comprising at least one thermoplastic hydrocarbon resin (solid) and at least one plasticizer (liquid) based on one or more isosorbide diesters of following general formula (I):

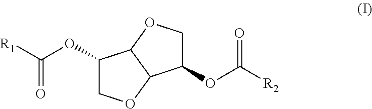

in which the R₁ and R₂ radicals, which are identical or different, independently represent a hydrocarbon radical comprising from 1 to 30 carbon atoms.

Furthermore, the presence of a liquid plasticizing agent, as defined above and of natural origin, makes it possible to obtain a final rubber composition, with all its constituents, exhibiting a glass transition temperature, before curing, which is virtually identical to the glass transition temperatures of the said compositions obtained with the plasticizing systems used to date. Compounds of this type (isosorbide diesters) are described in particular in EP 1058711 or WO 99/045060 as thermoplastic solvent or plasticizer, such as PVC.

Preferably, an embodiment of the invention relates to a tire as defined above in which the R₁ and R₂ radicals, which are identical or different, independently represent a hydrocarbon radical chosen from saturated or unsaturated and linear, branched or cyclic aliphatic radicals comprising from 1 to 30 carbon atoms, and aryls, aralkyls or alkaryls comprising from 6 to 30 carbon atoms. Preferably, the R₁ and R₂ radicals, which are identical or different, independently represent a hydrocarbon radical comprising from 2 to 18 carbon atoms which is optionally interrupted by one or more heteroatoms. Preferably again, the R₁ and R₂ radicals are identical.

Preferably again, an embodiment of the invention relates to a tire as defined above in which the plasticizer based on one or more isosorbide diesters is preferably present in an amount ranging from 5 to 50 phr and more preferably in an amount ranging from 10 to 30 phr.

Preferably again, an embodiment of the invention relates to a tire as defined above in which the plasticizer based on isosorbide diester has a glass transition temperature (Tg) of less than 0° C., preferably of less than −10° C. and more preferably of less than −20° C. and in particular ranging from −30° C. to −60° C.

Preferably, an embodiment of the invention relates to a tire as defined above in which the thermoplastic hydrocarbon resin preferably exhibits a glass transition temperature (Tg) of greater than 0° C., more preferably of greater than 20° C. The thermoplastic hydrocarbon resin is preferably selected from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins. The thermoplastic hydrocarbon resin is preferably present in an amount of between 5 and 60 phr.

Preferably again, an embodiment of the invention relates to a tire as defined above in which the diene elastomer is preferably selected from the group consisting of polybutadienes, synthetic polyisoprenes, natural rubber, butadiene copolymers, isoprene copolymers and the mixtures of these elastomers.

Preferably again, an embodiment of the invention relates to a tire as defined above in which the reinforcing filler comprises carbon black. Preferably again, the reinforcing filler comprises an inorganic filler, preferably in an amount of between 30 and 150 phr.

The tires of embodiments of the invention are intended in particular to equip motor vehicles of passenger vehicle or SUV (“Sport Utility Vehicles”) type, two-wheel vehicles (in particular motorcycles), aircraft or industrial vehicles chosen from vans, heavy-duty vehicles—that is to say, underground, bus, heavy road transport vehicles (lorries, tractors or trailers) or off-road vehicles, such as agricultural vehicles or earthmoving equipment—or other transportation or handling vehicles.

### DETAILED DESCRIPTION OF SPECIFIC EMBODIMENTS

The invention will now be described in detail using the technical elements and examples which follow given solely by way of illustration.

In the present description, unless expressly indicated otherwise, all the percentages (%) shown are percentages by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### Diene Elastomer

The term “diene” elastomer or rubber should be understood as meaning, in a known way, an (one or more are understood) elastomer resulting at least in part (i.e., a homopolymer or a copolymer) from diene monomers (monomers carrying two carbon-carbon double bonds which may or may not be conjugated).

These diene elastomers can be classified into two categories: “essentially unsaturated” or “essentially saturated”. The term “essentially unsaturated” is understood to mean generally a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content of units of diene origin, always less than 15%). In the category of “essentially unsaturated” diene elastomers, the term “highly unsaturated” diene elastomer is understood to mean in particular a diene elastomer having a content of units of diene origin (conjugated dienes) which is greater than 50%.

Given these definitions, the term diene elastomer capable of being used in the compositions in accordance with the invention is understood more particularly to mean:

any homopolymer obtained by polymerization of a conjugated diene monomer having from 4 to 12 carbon atoms;
any copolymer obtained by copolymerization of one or more conjugated dienes with one another or with one or more vinylaromatic compounds having from 8 to 20 carbon atoms;
a ternary copolymer obtained by copolymerization of ethylene and of an α-olefin having 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
a copolymer of isobutene and of isoprene (butyl rubber) and also the halogenated versions, in particular chlorinated or brominated versions, of this type of copolymer.

Although it applies to any type of diene elastomer, a person skilled in the art of tires will understand that an embodiment of the present invention is preferably employed with essentially unsaturated diene elastomers, in particular of the type (a) or (b) above.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or also functionalized with a coupling and/or star-branching or functionalization agent. For coupling with carbon black, mention may be made, for example, of functional groups comprising a C—Sn bond or of aminated functional groups, such as benzophenone, for example; for coupling with a reinforcing inorganic filler, such as silica, mention may be made, for example, of silanol functional groups or polysiloxane groups having a silanol end (such as described, for example, in FR 2 740 778 or U.S. Pat. No. 6,013,718), of alkoxysilane groups (such as described, for example, in FR 2 765 882 or U.S. Pat. No. 5,977,238), of carboxyl groups (such as described, for example, in WO 01/92402 or U.S. Pat. No. 6,815,473, WO 2004/096865 or US 2006/0089445) or of polyether groups (such as described, for example, in EP 1 127 909 or U.S. Pat. No. 6,503,973).

The following are suitable: polybutadienes, in particular those having a content (molar %) of 1,2-units of between 4% and 80% or those having a content (molar %) of cis-1,4-units of greater than 80%, polyisoprenes, butadiene/styrene copolymers and in particular those having a Tg (glass transition temperature, measured according to Standard ASTM D3418) of between 0° C. and −70° C. and more particularly between −10° C. and −60° C., a styrene content of between 5% and 60% by weight and more particularly between 20% and 50%, a content (molar %) of 1,2-bonds of the butadiene part of between 4% and 75% and a content (molar %) of trans-1,4-bonds of between 10% and 80%, butadiene/isoprene copolymers, in particular those having an isoprene content of between 5% and 90% by weight and a Tg of −40° C. to −80° C., or isoprene/styrene copolymers, in particular those having a styrene content of between 5% and 50% by weight and a Tg of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content (molar %) of 1,2-units of the butadiene part of between 4% and 85%, a content (molar %) of trans-1,4-units of the butadiene part of between 6% and 80%, a content (molar %) of 1,2plus 3,4-units of the isoprene part of between 5% and 70% and a content (molar %) of trans-1,4-units of the isoprene part of between 10% and 50%, and more generally any butadiene/styrene/isoprene copolymer having a Tg of between −20° C. and −70° C., are suitable in particular.

To sum up, the diene elastomer of the composition in accordance with an embodiment of the invention is preferably selected from the group of the highly unsaturated diene elastomers consisting of polybutadienes (abbreviated to “BRs”), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

According to a specific embodiment, the diene elastomer is predominantly (i.e., for more than 50 phr) an SBR, whether an SBR prepared in emulsion (“ESBR”) or an SBR prepared in solution (“SSBR”), or an SBR/BR, SBR/NR (or SBR/IR), BR/NR (or BR/IR) or also SBR/BR/NR (or SBR/BR/IR) blend (mixture). In the case of an SBR (ESBR or SSBR) elastomer, use is made in particular of an SBR having a moderate styrene content, for example of between 20% and 35% by weight, or a high styrene content, for example from 35 to 45%, a content of vinyl bonds of the butadiene part of between 15% and 70%, a content (molar %) of trans-1,4-bonds of between 15% and 75% and a Tg of between −10° C. and −55° C.; such an SBR can advantageously be used as a mixture with a BR preferably having more than 90% (molar %) of cis-1,4-bonds.

According to another specific embodiment, the diene elastomer is predominantly (for more than 50 phr) an isoprene elastomer. This is the case in particular when the compositions of the invention are intended to constitute, in the tires, rubber matrices of certain treads (for example for industrial vehicles), of crown reinforcing plies (for example of working plies, protection plies or hooping plies), of carcass reinforcing plies, of sidewalls, of beads, of protectors, of underlayers, of rubber blocks and other internal rubbers providing the interface between the abovementioned regions of the tires.

The term “isoprene elastomer” is understood to mean, in a known way, an isoprene homopolymer or copolymer, in other words a diene elastomer chosen from the group consisting of natural rubber (NR), synthetic polyisoprenes (IRs), the various copolymers of isoprene and the mixtures of these elastomers. Mention will in particular be made, among isoprene copolymers, of isobutene/isoprene copolymers (butyl rubber-IIR), isoprene/styrene copolymers (SIRs), isoprene/butadiene copolymers (BIRs) or isoprene/butadiene/styrene copolymers (SBIRs). This isoprene elastomer is preferably natural rubber or a synthetic cis-1,4-polyisoprene; use is preferably made, among these synthetic polyisoprenes, of the polyisoprenes having a content (molar %) of cis-1,4-bonds of greater than 90%, more preferably still of greater than 98%.

According to another preferred embodiment of the invention, the rubber composition comprises a blend of a (one or more) “high Tg” diene elastomer exhibiting a Tg of between −70° C. and 0° C. and of a (one or more) “low Tg” diene elastomer of between −110° C. and −80° C., more preferably between −105° C. and −90° C. The high Tg elastomer is preferably selected from the group consisting of S-SBRs, E-SBRs, natural rubber, synthetic polyisoprenes (exhibiting a content (molar %) of cis-1,4-enchainments preferably of greater than 95%), BIRs, SIRs, SBIRs and the mixtures of these elastomers. The low Tg elastomer preferably comprises butadiene units according to a content (molar %) at least equal to 70%; it preferably consists of a polybutadiene (BR) exhibiting a content (molar %) of cis-1,4-enchainments of greater than 90%.

According to another specific embodiment of the invention, the rubber composition comprises, for example, from 30 to 100 phr, in particular from 50 to 100 phr, of a high Tg elastomer as a blend with 0 to 70 phr, in particular from 0 to 50 phr, of a low Tg elastomer; according to another example, it comprises, for the whole of the 100 phr, one or more SBR(s) prepared in solution.

According to another specific embodiment of the invention, the diene elastomer of the composition according to the invention comprises a blend of a BR (as low Tg elastomer) exhibiting a content (molar %) of cis-1,4-enchainments of greater than 90% with one or more S-SBRs or E-SBRs (as high Tg elastomer(s)).

The compositions of the invention can comprise a single diene elastomer or a mixture of several diene elastomers, it being possible for the diene elastomer or elastomers to be used in combination with any type of synthetic elastomer other than a diene elastomer, indeed even with polymers other than elastomers, for example thermoplastic polymers.

### Reinforcing Filler

Use may be made of any type of reinforcing filler known for its capabilities of reinforcing a rubber composition which can be used for the manufacture of tires, for example an organic filler, such as carbon black, a reinforcing inorganic filler, such as silica, or a blend of these two types of filler, in particular a blend of carbon black and silica.

All carbon blacks, in particular blacks of the HAF, ISAF or SAF type, conventionally used in tires (“tire-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or also, depending on the applications targeted, the blacks of higher series (for example, N660, N683 or N772). The carbon blacks might, for example, be already incorporated in the isoprene elastomer in the form of a masterbatch (see, for example, Applications WO 97/36724 or WO 99/16600).

Mention may be made, as examples of organic fillers other than carbon blacks, of the functionalized polyvinylaromatic organic fillers as described in Applications WO 2006/069792 and WO 2006/069793.

The term “reinforcing inorganic filler” should be understood, in the present patent application, by definition, as meaning any inorganic or mineral filler, whatever its colour and its origin (natural or synthetic), also known as “white filler”, “clear filler” or even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, the term reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16837.

When the compositions of the invention are intended for tire treads with a low rolling resistance, the reinforcing inorganic filler used, in particular if it is silica, preferably has a BET specific surface of between 45 and 400 m²/g, more preferably of between 60 and 300 m²/g.

Preferably, the content of total reinforcing filler (carbon black and/or reinforcing inorganic filler, such as silica) is between 20 and 200 phr, more preferably between 30 and 150 phr, the optimum being in a known way different depending on the specific applications targeted: the level of reinforcement expected with regard to a bicycle tire, for example, is, of course, less than that required with regard to a tire capable of running at high speed in a sustained manner, for example a motorcycle tire, a tire for a passenger vehicle or a tire for a utility vehicle, such as a heavy duty vehicle.

According to a preferred embodiment of the invention, use is made of a reinforcing filler comprising between 30 and 150 phr, more preferably between 50 and 150 phr and more preferably between 80 and 130 phr of inorganic filler, particularly silica, and optionally carbon black; the carbon black, when it is present, is preferably used at a content of less than 20 phr, more preferably of less than 10 phr (for example between 0.1 and 10 phr).

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “unsymmetrical” depending on their specific structure, as described, for example, in Applications WO 03/002648 (or US 2005/016651) and WO 03/002649 (or US 2005/016650).

“Symmetrical” silane polysulphides corresponding to the following general formula (III):

Z-A-S_{X}-A-Z (III), in which:
x is an integer from 2 to 8 (preferably from 2 to 5);
A is a divalent hydrocarbon radical (preferably C₁-C₁₈ alkylene groups or C₆-C₁₂ arylene groups, more particularly C₁-C₁₀, in particular C₁-C₄, alkylenes, especially propylene);
Z corresponds to one of the formulae below:

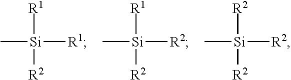

in which:

the R¹ radicals, which are unsubstituted or substituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl),

the R² radicals, which are unsubstituted or substituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl), are suitable in particular, without the above definition being limiting.

In the case of a mixture of alkoxysilane polysulphides corresponding to the above formula (III), in particular the usual mixtures available commercially, the mean value of the “x” index is a fractional number preferably of between 2 and 5, more preferably in the vicinity of 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, as described in Patent Application WO 02/083782 (or US 2004/132880).

Mention will in particular be made, as coupling agent other than alkoxysilane polysulphide, of bifunctional POSs (polyorganosiloxanes) or of hydroxysilane polysulphides (R²═OH in the above formula III), such as described in Patent Applications WO 02/30939 (or U.S. Pat. No. 6,774,255) and WO 02/31041 (or US 2004/051210), or also of silanes or POSs carrying azodicarbonyl functional groups, such as described, for example, in Patent Applications WO 2006/125532, WO 2006/125533 and WO 2006/125534.

In the rubber compositions in accordance with the invention, the content of coupling agent is preferably between 4 and 12 phr, more preferably between 3 and 8 phr.

A person skilled in the art will understand that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

### Plasticizing System

The rubber composition according to an embodiment of the invention comprises a plasticizing system comprising at least, as first plasticizer, one thermoplastic hydrocarbon resin and at least, as second plasticizer, one plasticizer based on one or more isosorbide diesters of following formula (I):

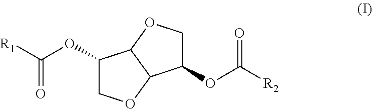

in which the R₁ and R₂ radicals, which are identical or different, independently represent a hydrocarbon radical comprising from 1 to 30 carbon atoms.

In a way known to a person skilled in the art, the first plasticizer, also known as “plasticizing resin”, is reserved in the present patent application, by definition, for hydrocarbon resins, essentially based on carbon and hydrogen but being able to comprise other types of atoms, which can be used in particular as plasticizing agents or tackifying agents in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tire rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). Their Tg is preferably greater than 0° C., in particular greater than 20° C. (generally between 30° C. and 95° C.).

In a known way, these hydrocarbon resins can also be described as thermoplastic resins in the sense that they soften when heated and can thus be moulded. They can also be defined by a softening point or temperature. The softening point of a hydrocarbon resin is generally greater by approximately 50 to 60° C. than its Tg value. The softening point is measured according to Standard ISO 4625 (Ring and Ball method). The macrostructure (Mw, Mn and PI) is determined by size exclusion chromatography (SEC) as indicated below.

As a reminder, the SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran, at a concentration of 1 g/litre. The solution is then filtered through a filter with a porosity of 0.45 μm, before injection into the apparatus. The apparatus used is, for example, a Waters Alliance chromatographic line according to the following conditions: elution solvent: tetrahydrofuran; temperature 35° C.; concentration 1 g/litre; flow rate: 1 ml/min; volume injected: 100 μl; Moore calibration with polystyrene standards; set of 3 Waters columns in series (Styragel HR4E, Styragel HR1 and Styragel HR 0.5); detection by differential refractometer (for example, Waters 2410) which can be equipped with operating software (for example, Waters Millennium).

A Moore calibration is carried out with a series of commercial polystyrene standards having a low PI (less than 1.2), with known molar masses, covering the range of masses to be analysed. The weight-average molar mass (Mw), the number-average molar mass (Mn) and the polydispersity index (PI=Mw/Mn) are deduced from the data recorded (curve of distribution by mass of the molar masses). All the values for molar masses shown in the present patent application are thus relative to calibration curves produced with polystyrene standards.

According to a preferred embodiment of the invention, the hydrocarbon resin exhibits at least any one, more preferably all, of the following characteristics:

a Tg of greater than 25° C. (in particular between 30° C. and 100° C.), more preferably of greater than 30° C. (in particular between 30° C. and 95° C.);

a softening point of greater than 50° C. (in particular between 50° C. and 150° C.);

a number-average molar mass (Mn) of between 400 and 2000 g/mol, preferably between 500 and 1500 g/mol;

a polydispersity index (PI) of less than 3, preferably of less than 2 (as a reminder: PI=Mw/Mn with Mw the weight-average molar mass).

Mention may be made, as examples of such hydrocarbon resins, of those selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, terpene/phenol copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomer are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins and the mixtures of these resins.

All the above resins are well known to a person skilled in the art and are commercially available, for example sold by DRT under the name Dercolyte as regards polylimonene resins, by Neville Chemical Company under the name Super Nevtac, by Kolon under the name Hikorez or by Exxon Mobil under the name Escorez as regards C₅ fraction/styrene resins or C₅ fraction/C₉ fraction resins, or else by Struktol under the name 40 MS or 40 NS (mixtures of aromatic and/or aliphatic resins).

The content of hydrocarbon resin is preferably between 5 and 60 phr. Below the minimum indicated, the targeted technical effect can prove to be insufficient whereas, above 60 phr, the tackiness of the compositions in the raw state, with regard to the compounding devices, can in some cases become totally unacceptable from the industrial viewpoint. For these reasons, the content of hydrocarbon resin is more preferably between 5 and 40 phr and more preferably still between 10 and 30 phr.

The plasticizing system according to embodiments of the invention furthermore comprises at least, as second (liquid) plasticizer, one plasticizer based on one or more isosorbide diesters of general formula (I):

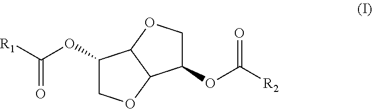

in which the R₁ and R₂ radicals, which are identical or different, independently represent a hydrocarbon radical comprising from 1 to 30 carbon atoms, optionally interrupted by one or more heteroatoms.

Preferably, the R₁ and R₂ radicals, which are identical or different, independently represent a hydrocarbon radical chosen from saturated or unsaturated and linear, branched or cyclic aliphatic (in particular alkyl) radicals comprising from 1 to 30 carbon atoms, and aryls, aralkyls or alkaryls comprising from 6 to 30 carbon atoms.

Preferably, the R₁ and R₂ radicals, which are identical or different, independently represent a hydrocarbon radical comprising from 2 to 18 carbon atoms which is optionally interrupted by one or more heteroatoms. Preferably again, the R₁ and R₂ radicals are identical.

The term “radical interrupted by one or more heteroatoms” is understood to mean a radical comprising one or more heteroatoms, each heteroatom being comprised between two carbon atoms of the said radical or between a carbon atom of the said radical and another heteroatom of the said radical or between two other heteroatoms of the said radical. The heteroatom or heteroatoms can be nitrogen, sulphur or oxygen.

Preferably, the plasticizer based on isosorbide diester has a glass transition temperature (Tg) of less than 0° C., preferably of less than −10° C. and more particularly of less than −20° C. and in particular ranging from −30° C. to −60° C.

The term “plasticizer based on one or more isosorbide diesters of general formula (I)” is understood to mean, within the meaning of the present invention, a liquid plasticizer predominantly composed of compounds of general formula (I), with just one compound of formula (I) or a mixture of compounds of formula (I).

The plasticizers based on one or more isosorbide diesters of general formula (I) can be prepared from the isosorbide in a way known to a person skilled in the art by esterification with carboxylic acids, for example fatty acids. Some are also available commercially, such as Polysorb ID 37 from Roquette.

The diester according to the invention can be present in an amount ranging from 5 to 50 phr and preferably from 10 to 30 phr. As a reminder, the unit “phr” means “parts by weight per hundred parts of elastomer”.

### Various Additives

The rubber compositions in accordance with the invention can also comprise all or a portion of the usual additives generally used in elastomer compositions intended for the manufacture of tires or semi-finished products for tires, such as, for example, other plasticizing agents, preferably non-aromatic or very slightly aromatic plasticizing agents, for example naphthenic or paraffinic oils, MES or TDAE oils, glycerol esters (in particular trioleates), especially natural esters, such as rapeseed or sunflower vegetable oils, pigments, protection agents, such as antiozone waxes, chemical antiozonants, antioxidants, antifatigue agents, reinforcing resins, methylene acceptors (for example, phenolic novolak resin) or methylene donors (for example, HMT or H3M), a crosslinking system based either on sulphur or on sulphur donors and/or on peroxide and/or on bismaleimides, vulcanization accelerators, vulcanization activators or antireversion agents.

These compositions can also comprise, in addition to coupling agents, coupling activators, agents for covering the inorganic fillers or more generally processing aids capable, in a known way, by virtue of an improvement in the dispersion of the filler in the rubber matrix and of a lowering in the viscosity of the compositions, of improving their ability to be processed in the raw state, these agents being, for example, hydrolysable silanes, such as alkylalkoxysilanes, polyols, polyethers, primary, secondary or tertiary amines or hydroxylated or hydrolysable polyorganosiloxanes.

### Manufacture of the Rubber Compositions

The compositions are manufactured in appropriate mixers using two successive preparation phases well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) up to a lower temperature, typically of less than 110° C., for example between 40° C. and 100° C., finishing phase during which the crosslinking system is incorporated.

The process in accordance with an embodiment of the invention for preparing a rubber composition comprises the following stages:

incorporating in a diene elastomer, during a first stage (“non-productive” stage), at least one reinforcing filler, one plasticizing resin and one ester plasticizer, everything being kneaded thermomechanically, in one or more goes, until a maximum temperature of between 110° C. and 190° C. is reached;

cooling the combined mixture to a temperature of less than 100° C.;

subsequently incorporating, during a second stage (“productive” stage), a crosslinking system;

kneading everything up to a maximum temperature of less than 110° C.,

the said ester plasticizer corresponding to the abovementioned formula (I) and, preferably, to the abovementioned preferred characteristics.

By way of example, the non-productive phase is carried out in a single thermomechanical stage during which, in a first step, all the necessary base constituents (diene elastomer, reinforcing filler and coupling agent, if necessary, plasticizers) are introduced, in one or more goes, into an appropriate mixer, such as a normal internal mixer, followed, in a second step, for example after kneading for one to two minutes, by the other additives, optional additional covering agents or processing aids, with the exception of the crosslinking system. After cooling the mixture thus obtained, the crosslinking system is then incorporated in an external mixer, such as an open mill, maintained at a low temperature (for example, between 40° C. and 100° C.). The combined mixture is then mixed (productive phase) for a few minutes, for example between 2 and 15 min.

The crosslinking system is preferably a vulcanization system based on sulphur and on an accelerator. Use may be made of any compound capable of acting as accelerator of the vulcanization of diene elastomers in the presence of sulphur, in particular those selected from the group consisting of 2-mercaptobenzothiazyl disulphide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-tert-butyl-2-benzothiazolesulphenamide (abbreviated to “TBBS”), N-tert-butyl-2-benzothiazolesulphenimide (abbreviated to “TBSI”) and the mixtures of these compounds. Preferably, a primary accelerator of the sulphenamide type is used.

Additional to this vulcanization system are various known secondary accelerators or vulcanization activators, such as zinc oxide, stearic acid, guanidine derivatives (in particular diphenylguanidine), and the like, incorporated during the first non-productive phase and/or during the productive phase. The content of sulphur is, for example, between 0.5 and 3.0 phr and that of the primary accelerator is between 0.5 and 5.0 phr.

The final composition thus obtained is subsequently calendered, for example in the form of a sheet or of a plaque, in particular for laboratory characterization, or else is extruded in the form of a rubber profiled element which can be used, for example, as a tire tread for a passenger vehicle.

The vulcanization (or curing) is carried out in a known way at a temperature generally of between 130° C. and 200° C. for a sufficient time which can vary, for example, between 5 and 90 min depending in particular on the curing temperature, the vulcanization system adopted and the vulcanization kinetics of the composition under consideration.

The invention relates to tires described above both in the “raw” state (i.e., before curing) and in the “cured” or vulcanized state (i.e., after vulcanization).

The tires obtained are characterized, before and after curing, according to the measurements and tests set out below.

1. Mooney Plasticity

Use is made of an oscillating consistometer as described in French Standard NF T 43-005 (1991). The Mooney plasticity measurement is carried out according to the following principle: the composition in the raw state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 newton.metre).

2. Tensile Tests

These tests make it possible to determine the elasticity stresses and the properties at break. Unless otherwise indicated, they are carried out in accordance with French Standard NF T 46-002 of September 1988. The “nominal” secant moduli (or apparent stresses, in MPa) or the “true” secant moduli (reduced in this case to the real cross section of the test specimen) are measured in second elongation (i.e., after a cycle of accommodation) at 10% elongation (denoted “M10” and “E10” respectively), 100% elongation (“M100” and “E100” respectively) and 300% elongation (“M300” and “E300” respectively). All these tensile measurements are carried out under the standard conditions of temperature (23±2° C.) and hygrometry (50±5% relative humidity) according to French Standard NF T 40-101 (December 1979). The breaking stresses (in MPa) and the elongations at break (in %) are also measured, at a temperature of 23° C.

3. Dynamic Properties

The dynamic properties G* and tan(δ)max are measured on a viscosity analyser (Metravib VA4000) according to Standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, under the standard temperature conditions (23° C.) according to Standard ASTM D1349-99, is recorded. A strain amplitude sweep is carried out from 0.1% to 50% (outward cycle) and then from 50% to 1% (return cycle). The results made use of are the complex dynamic shear modulus (G*) and the loss factor tan(δ). The maximum value of tan(δ) observed (tan(δ)max) between the values at 0.15% and at 50% strain is shown for the return cycle.

As a reminder, in a way well known to a person skilled in the art, the value of tan(δ)max (according to a “strain” sweep, at a temperature of 23° C.) is representative of the hysteresis and of the rolling resistance (the lower tan(δ)max, the lower the hysteresis and thus the rolling resistance). The modulus G* is representative of the stiffness.

### Examples of Rubber Compositions

1/Preparation of the Rubber Compositions

The tests which follow are carried out in the following way: the reinforcing filler, the coupling agent, the plasticizing system, the diene elastomer and the various other ingredients, with the exception of the vulcanization system, are successively introduced into a laboratory internal mixer, 70% filled and having an initial vessel temperature of approximately 60° C. Thermomechanical working (non-productive phase) is then carried out in one stage, which lasts in total approximately from 3 to 4 minutes, until a maximum “dropping” temperature of 165° C. is reached. The mixture thus obtained is recovered and cooled and then sulphur and an accelerator of sulphenamide type are incorporated on an external mixer (homofinisher) at 30° C., the combined mixture being mixed (productive phase) for an appropriate time (for example, between 5 and 12 min).

The compositions thus obtained are subsequently calendered, either in the form of plaques (thickness of 2 to 3 mm) or of fine sheets of rubber, for the measurement of their physical or mechanical properties, or extruded in the form of treads for passenger vehicle tires.

2/Rubber Tests

The aim of this test is to demonstrate the improved performance of rubber compositions according to the invention, in comparison with control compositions of the prior art. For this, six compositions based on SBR diene elastomers reinforced with silica and carbon black are prepared, the formulation of which is suited to the manufacture of tire treads.

The six compositions tested are identical, except for the nature of one of their components (second plasticizer, liquid):
Compositions 1, 2 and 3 (prior art): liquid plasticizer: sunflower oil;
Compositions 4, 5 and 6 (according to the invention): liquid plasticizer: plasticizer based on one or more isosorbide diesters. The plasticizer based on one or more isosorbide diesters used according to the invention is sold by Roquette essentially for the plastification of PVC.

Use is made, as first (solid) plasticizer, in each of the six compositions, of a plasticizing hydrocarbon resin of the C₅/C₉ fraction type. Compositions 1, 2 and 3 are reference compositions for the Applicant Companies, having furthermore proved their excellent performance in terms of wear resistance or abrasion resistance, on the one hand, and of rolling resistance, on the other hand.

The formulations of the six compositions (1, 2 and 3 of the prior art and 4, 5 and 6 of the invention), as parts by weight “phr”, are given in the following Table 1.

TABLE 1

| | 1 | 2 | 3 | 4 | 5 | 6 |
|---|---|---|---|---|---|---|
| SBR (1) | 100 | 100 | 100 | 100 | 100 | 100 |
| Silica (2) | 110 | 110 | 110 | 110 | 110 | 110 |
| Coupling | 8.80 | 8.80 | 8.80 | 8.80 | 8.80 | 8.80 |
| agent (3) | | | | | | |
| Carbon | 3 | 3 | 3 | 3 | 3 | 3 |
| black (4) | | | | | | |
| SO (5) | 10 | 15 | 20 | — | — | — |
| Isosorbide | — | — | — | 10 | 15 | 20 |
| diester (6) | | | | | | |
| Plasticizing | 35 | 35 | 35 | 35 | 35 | 35 |
| resin (7) | | | | | | |
| DPG (8) | 2 | 2 | 2 | 2 | 2 | 2 |
| ZnO | 1 | 1 | 1 | 1 | 1 | 1 |
| Stearic acid | 2 | 2 | 2 | 2 | 2 | 2 |
| Sulphur | 1.30 | 1.30 | 1.30 | 1.30 | 1.30 | 1.30 |
| Antiozone wax | 1.65 | 1.65 | 1.65 | 1.65 | 1.65 | 1.65 |
| Antioxidant (9) | 2.2 | 2.2 | 2.2 | 2.2 | 2.2 | 2.2 |
| Accelera- | 2 | 2 | 2 | 2 | 2 | 2 |
| tor (10) | | | | | | |

(1) Solution SBR with 41% of styrene units and 24% of 1,2- units of the butadiene part (Tg = −28° C.);
(2) Silica, Zeosil 1165 MP from Rhodia (HDS type);
(3) Coupling agent, TESPT (Si 69 from Evonik);
(4) ASTM grade N234 (Cabot);
(5) Sunflower oil, Lubrirob Tod 1880 from Novance;
(6) Plasticizer based on one or more isosorbide diesters: Polysorb ID 37 from Roquette;
(7) C₅/C₉ Resin (Escorez ECR-373 from Exxon Mobil);
(8) Diphenylguanidine (Perkacit DPG from Flexsys);
(9) N-(1,3-Dimethylbutyl)-N′-phenyl-p-phenylenediamine (Flexsys);
(10) N-Dicyclohexyl-2-benzothiazolesulphenamide (Santocure CBS from Flexsys).

The total amount of plasticizer (resin and liquid plasticizer) was adjusted in the compositions according to the invention in order to maintain the stiffness (Shore hardness) of the treads at a substantially constant level for a good comparison of the performances of the tires.

The properties observed with regard to the six compositions (1, 2 and 3 of the prior art and 4, 5 and 6 of the invention) after curing (30 min at 150° C.) are given in Table 2.

TABLE 2

| | 1 | 2 | 3 | 4 | 5 | 6 |
|---|---|---|---|---|---|---|
| M300 | 4.06 | 3.69 | 3.07 | 4.45 | 4.12 | 3.88 |
| M100 | 2.59 | 2.31 | 1.94 | 2.81 | 2.56 | 2.36 |
| tan(δ)max (23° C.) | 0.40 | 0.36 | 0.34 | 0.35 | 0.32 | 0.33 |
| Mooney | 72 | 63 | 54 | 75 | 66 | 59 |
| G* 10% Return (MPa) | 3.49 | 3.04 | 2.68 | 3.66 | 3.23 | 3.03 |

From reading Table 2, it may be noted that the compositions according to the invention, compared with the control compositions (with an identical concentration of plasticizing system), exhibit the following characteristics:
a notable increase in the M100 and M300 moduli, which illustrates a high level of reinforcing of the compositions of the invention and an improved wear resistance potential for the treads of the tires in accordance with the invention,
a stiffening of the matrix by an increase in G*10%, and
substantially improved dynamic properties with a value of tan(δ) at 23° C. which is lower for the compositions of the invention, the recognized indicator of an improved rolling resistance (reduction in the numerical value of tan(δ)max).

In conclusion, the use of the plasticizing system according to the invention makes it possible to obtain an increase in rolling resistance without damaging the other properties, which are the wear resistance and the road behaviour, indeed even while improving them.

1. A Tire, the tread of which comprises a rubber composition comprising at least:
a. one diene elastomer,
b. one reinforcing filler,
c. one plasticizing system comprising at least one thermoplastic hydrocarbon resin and at least one plasticizer based on one or more isosorbide diesters of following formula (I): 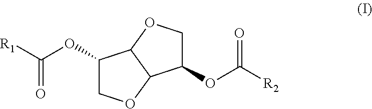
wherein the R₁ and R₂ radicals, which are identical or different, independently represent a hydrocarbon radical comprising from 1 to 30 carbon atoms, which is optionally interrupted by one or more heteroatoms.

2. The tire according to claim 1, wherein the R₁ and R₂ radicals, which are identical or different, independently represent a hydrocarbon radical chosen from saturated or unsaturated and linear, branched or cyclic aliphatic radicals comprising from 1 to 30 carbon atoms, and aryls, aralkyls or alkaryls comprising from 6 to 30 carbon atoms.

3. The tire according to claim 1, wherein the R₁ and R₂ radicals, which are identical or different, independently represent a hydrocarbon radical comprising from 2 to 18 carbon atoms which is optionally interrupted by one or more heteroatoms.

4. The tire according to claim 1, wherein the plasticizer based on one or more isosorbide diesters is present in an amount ranging from 5 to 50 phr, and preferably from 10 to 30 phr.

5. The tire according to claim 1, wherein the plasticizer based on isosorbide diester has a glass transition temperature (Tg) of less than 0° C.

6. The tire according to claim 5, wherein the plasticizer based on one or more isosorbide diesters exhibits a glass transition temperature (Tg) ranging from −30° C. to −60° C.

7. The tire according to according to claim 1, wherein the thermoplastic hydrocarbon resin exhibits a glass transition temperature (Tg) of greater than 0° C.

8. The tire according to claim 1, wherein the thermoplastic hydrocarbon resin is selected from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins.

9. The tire according to claim 1, wherein the thermoplastic hydrocarbon resin is present in an amount of ranging from 5 to 60 phr.

10. The tire according to claim 1, wherein the diene elastomer is selected from the group consisting of polybutadienes, synthetic polyisoprenes, natural rubber, butadiene copolymers, isoprene copolymers and the mixtures of these elastomers.

11. The tire according to claim 1, wherein the reinforcing filler comprises carbon black.

12. The tire according to claim 1, wherein the reinforcing filler comprises an inorganic filler.

13. The tire according to claim 5, wherein the plasticizer based on isosorbide diester has a glass transition temperature (Tg) of less than −10° C.

14. The tire according to claim 12, wherein the inorganic filler is present in an amount between 30 and 150 phr.
